(19) United States
(12) Patent Application Publication
(10) Pub. No.: US 2010/0043075 A1
(43) Pub. Date: Feb. 18, 2010

(54) LICENSING MANAGEMENT UTILITY

(75) Inventor: Shelli Marie Byers, Cloverdale, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: Autodesk, Inc., San Rafael, CA (US)

(21) Appl. No.: 12/191,050

(22) Filed: Aug. 13, 2008

(51) Int. Cl. G06F 21/00

(52) U.S. Cl. 726/26

(57) ABSTRACT

A computer implemented method, apparatus, and article of manufacture are used to activate multiple computer applications on a computer. A computer application is installed. Further, a single licensing management utility (LMU) that is shared by multiple computer applications is installed on the computer. The LMU determines if a license for the installed computer application exists and obtains the license if it does not.

### BACKGROUND OF THE INVENTION

1. Field of the Invention

The present invention relates generally to computer software, and in particular, to a method, apparatus, and article of manufacture for managing software licenses for a plethora of products in a network environment.

2. Description of the Related Art

Traditionally, software licenses that accompany a software application are shipped with the box that contains the software. The install of the software components requires that the license be added (or entered) during the install process. In a networked environment a software license may be part of a pool of available licenses. When the application is started, a license is pulled from the pool and the number of licenses is decremented by one. However, the prior art fails to provide an efficient mechanism for managing product licenses for multiple products without separately and independently starting each of the applications or separate utilities for each of the applications. The problem may be better understood with a detailed description of prior art licensing schemes.

In the prior art, two software components may be utilized for managing software licenses. One software component handles network licensing (called FLEXlm™ available from Acresso Software™) and an additional component handles stand-alone licensing (called SafeCast™ available from Macrovision™). FIG. 1 illustrates an example of a prior art methodology for managing software licenses used by the assignee of the present invention, Autodesk, Inc.™ When the user installs a product (e.g., a network product A 102 (such as AutoCAD™ available from the present assignee), a stand-alone product B 104 (such as Maya™ available from the present assignee), or a stand-alone product C 106 (such as Inventor™ available from the present assignee), the product installs a licensing manager component 108A-108C (referred to herein as an Autodesk Licensing Manager (ADLM)™ component) for each software product 102-106.

As used herein, a standalone product 104-106 refers to a product that is installed on a workstation. The license for the product is also located on the workstation. Each workstation must be “activated” for the license to allow the software to run. Further, a network product 102 refers to a product that is installed on one or more workstations with the licenses located on a network server. The network server is “activated” for an appropriate number of licenses. On launch of the software 102, the software 102 requests a license to run the product from the network server. If there are licenses available on the server, the product runs; if no licenses are available on the server and the product will close.

In the prior art, if the product is a stand-alone product (e.g., products 104 and 106), the component 108B or 108C installs a SafeCast™ component 110. Alternatively, if the product is a network-based product 102, the FLEXlm™ component 112 is installed. The SafeCast™ and/or FLEXlm™ components manage and store the licenses for the various products 102-106. Different user interfaces (referred to as dashboards 114A-114C) are used to activate and manage the licenses for each product 102-106. In this regard, the ADLMs 108A-C function as a bridge between the application 102-106 and the underlying licensing management component 110-112.

Thus, as can be seen, different dashboards 114A-C must be individually launched by the user to manage the licenses for the different products 102-106. Further, individual and different ADLMs 108A-108C must be created for each product 102-106. Further yet, different licensing management components 110 and 112 are necessary to manage licenses for stand-alone software products 104-106 and network software products 102. Accordingly, what is necessary is a mechanism for easily and efficiently managing software licenses for multiple software applications (stand-alone or network-based).

### SUMMARY OF THE INVENTION

To overcome the problems of the prior art, the embodiments of the present invention utilize a single license management utility (LMU) that all products on a computer share. A single copy of the LMU is installed on an individual computer/network. The LMU allows the user to view (e.g., through a graphical user interface referred to as a dashboard) the status of each product and license in one location, both local single license and networked licenses. The LMU provides the ability to install different products that all use the same licensing component without having to go through the same licensing steps for each individual component. All of the different software products use a common licensing scheme/component.

### BRIEF DESCRIPTION OF THE DRAWINGS

Referring now to the drawings in which like reference numbers represent corresponding parts throughout:

FIG. 1 illustrates an example of a prior art methodology for managing software licenses;

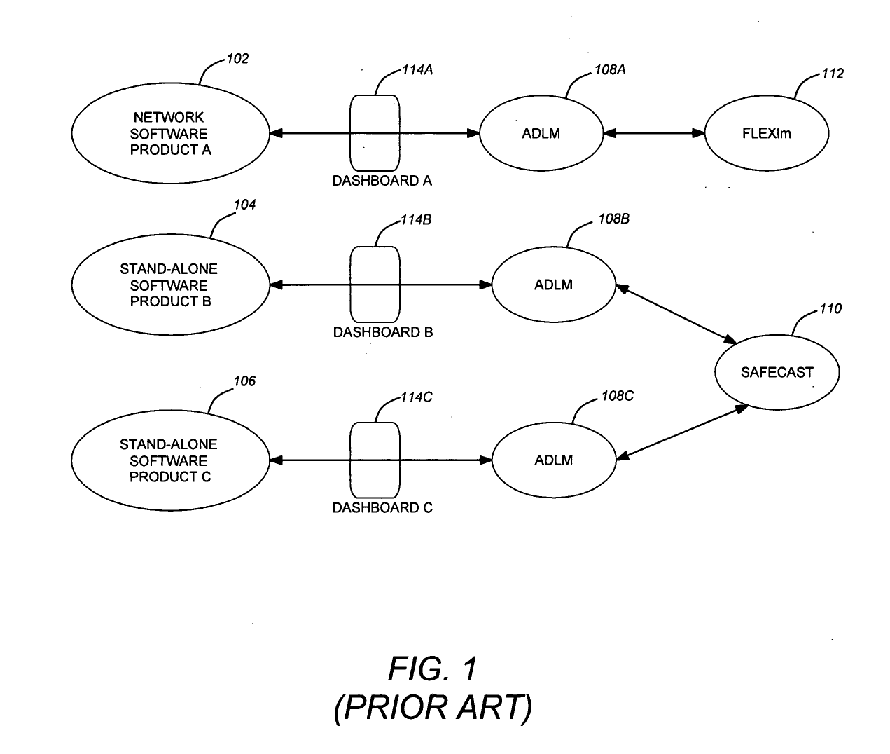

FIG. 2 schematically illustrates a hardware and software environment in accordance with one or more embodiments of the invention;

FIG. 3 illustrates an overview of the structure for the interaction of the various software licensing management components in accordance with one or more embodiments of the invention;

FIG. 4 illustrates the logical flow for multiple products enrolling into a common licensing management utility (LMU) in accordance with one or more embodiments of the invention; and

FIG. 5 illustrates a graphical user interface of a dashboard displayed in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Hardware and Software Environment

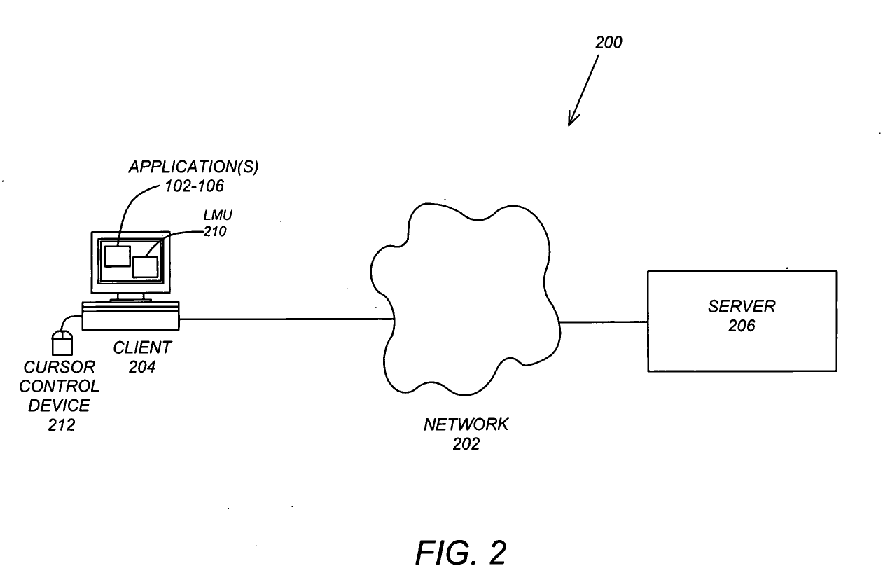

FIG. 2 schematically illustrates a hardware and software environment in accordance with one or more embodiments of the invention, and more particularly, illustrates a typical distributed computer system 200 using a network 202 to connect client computers 204 to server computers 206. A typical combination of resources may include a network 202 comprising the Internet, LANs, WANs, SNA networks, or the like, clients 204 that are personal computers or workstations, and servers 206 that are personal computers, workstations, minicomputers, or mainframes. Additionally, both client 204 and server 206 may receive input (e.g., cursor location input) and display a cursor in response to an input device such as cursor control device 212.

A network 202 such as the Internet connects clients 204 to server computers 206. Additionally, network 202 may utilize radio frequency (RF) to connect and provide the communication between clients 204 and servers 206. Clients 204 may execute client application(s) 102-106 and communicate with server computers 206. Alternatively, such applications 102-106 may execute on server 206. Further, such applications 102-106 executing on clients 204 may be downloaded from server computer 206 to client computers 204. In addition, client computers 204 or server computers 208 may execute a licensing management utility (LMU) 210 as described in further detail below.

Generally, the application(s) 102-106 and LMU 210 may comprise logic and/or data that is embodied in or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Thus, embodiments of the invention may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass logic and/or data accessible from any computer-readable device, carrier, or media.

Those skilled in the art will recognize many modifications may be made to this exemplary environment without departing from the scope of the present invention. For example, those skilled in the art will recognize that any combination of the above components, or any number of different components, including different logic, data, different peripherals, and different devices, may be used to implement the present invention, so long as similar functions are performed thereby.

### Detailed Software Embodiment

Embodiments of the invention are implemented in a single license management utility (LMU) 210 that all products 102-106 share. A single copy of the LMU 210 is installed on an individual computer 204 or server 206 (e.g., one copy of LMU 210 is shared amongst multiple computers 204 and/or 206 on a network 202). The LMU 210 allows the user to see the status of each product 102-106 and license in one location, both local single license and networked licenses.

The LMU 210 provides the ability to install multiple different products 102-106 (from one or more manufacturers/resellers/etc.) such as AutoCAD™, Inventor™, Revit™, Maya™, MAX™ (offered by the assignee of the present invention) that each use the same licensing component 210 without having to go through the same licensing steps for each individual component 102-106. Thus, multiple applications 102-106 may be installed on a computer 204/206 and all of such applications 102-106 may share/utilize a single installation of the LMU 210. As described in further detail below, the first product 102-106 that is installed will install the LMU 210. Subsequently installed products 102-106 merely find the LMU 210 and do not install another LMU 210. Thus, subsequent products 102-106 do not have to proceed with the same licensing steps. In this regard, all the different software products 102-106 use a common licensing scheme/component.

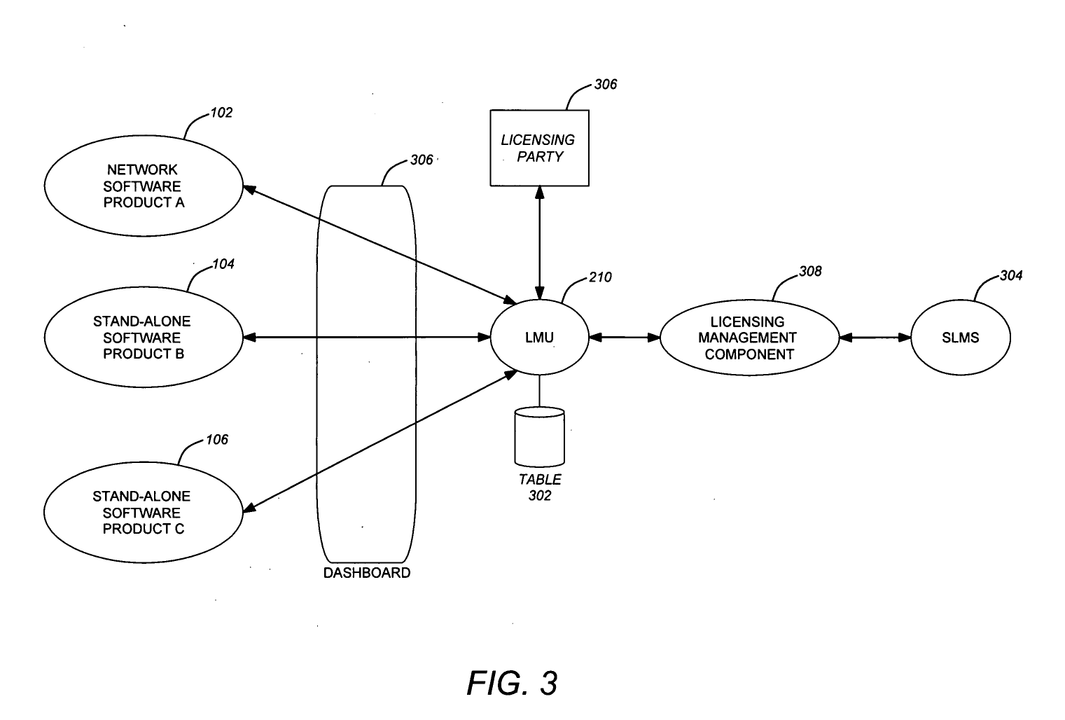

FIG. 3 illustrates an overview of the structure for the interaction of the various software licensing management components in accordance with one or more embodiments of the invention. When the user (e.g., client 204) installs a new product/application 102-106, the product 102-106 looks for the LMU 210. If the LMU 210 is not installed (i.e., it is the first time a product 102-106 using the schema of the invention is being installed), the LMU 210 is installed.

On subsequent occasions, the product 102-106 will find the LMU 210 and register itself with the LMU 210. The registration causes an update to a LMU table 302 with the product information (e.g., product name, product ID, product release, license type, license location, feature ID, version, serial number, service pack, and product language). The LMU 210 then communicates via a single licensing management component 308 (e.g., AdLM™) with software license management system (SLMS) 304 (e.g., FLEXnet™ software license management system available from Acresso™) which stores and manages the licenses. In alternative embodiments, the single licensing management component 308 may be installed for each product 102-106, all of which are managed by the LMU 210. The LMU 210 communicates with the SLMS 304 using application programming interface (API) calls through the licensing management component 308 (and vice versa). Further, the SLMS 304 is a secure area that is encoded and encrypted and provides a location where the licenses (for the various products 102-106) are actually stored.

In view of the above, all software products 102-106 communicate with the common LMU 210 which manages the licenses for all of the products 102-106 regardless of whether the product 102-106 is a stand-alone product (e.g., products 104 and 106) or is installed as a network 202 (e.g., product 102). In turn, the LMU 210 communicates via licensing management component 308 with the SLMS 304 component via application programming interface (API) calls. Further, the LMU 210 displays dialogs (e.g., in a dashboard 306) to obtain customer input necessary for the product activation sequence. It may be noted that all of the components of FIG. 3 (but for licensing party 306) may be located on the client 204 and not the network server 206.

With the use of the SLMS 304 component, the LMU 210 presents the user interface 306 to collect user input and the licensing management component 308 is used to make the API calls to the SLMS 304.

### Logical Flow

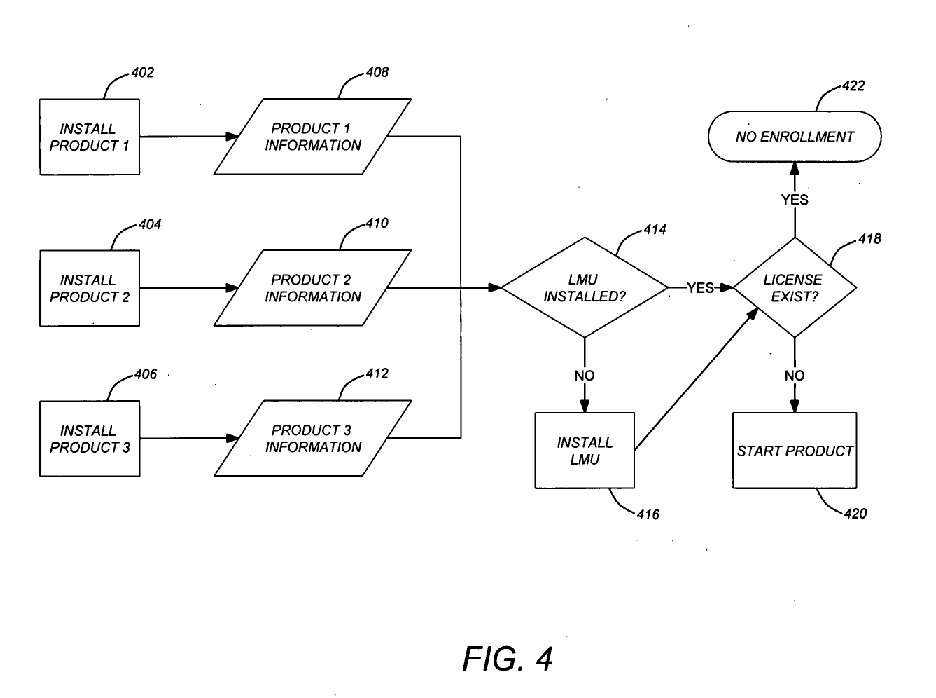

FIG. 4 illustrates the logical flow for multiple products enrolling into a common LMU in accordance with one or more embodiments of the invention.

Referring to both FIG. 3 and FIG. 4, when a user installs a product (e.g., products 1, 2, or 3) 402-406, product information 408-412 is generated/registered for the product. Such information may include the product name, product identification, product release, version, serial number, product key, etc. In this regard, the generation of the product information 408-412 refers to the passing to the LMU 414 of hard coded product information 408-412 during this process.

Upon initiating/starting up the product/application 402-406, the application 402-406 needs to be activated. Embodiments of the invention (as described above) control and provide for such activation. The product 402-406 first determines if the LMU 210 has been installed yet at step 414. If the LMU 414 has not been installed, it is installed at step 416.

Once the LMU 210 has been installed at step 416 or if an LMU 210 was already installed on the system, the LMU 210 determines if a license for the product 402-406 exists (e.g., by communicating with SLMS 304 via API calls of licensing management component 308) at step 418. The identification of the product 402-406 may be satisfied using a product key from the product information 408-412).

If the license does not exist, the process of obtaining a license is initiated by starting up the product 402-406 at step 420. Such a product startup step initiates the product activation sequence. On the customer choosing to continue the activation sequence, a request code is generated and transmitted to the licensing party 306 (i.e., the party responsible for managing licenses for the product such as vendor/manufacturer of the application 402-406). For example, an activation code for the AutoCAD™ drawing application may be transmitted to Autodesk™. The licensing party 306 verifies the product information 408-412 and returns an activation. The activation is passed to the LMU 210 which passes the activation to the underling licensing technologies (i.e., to the SLMS 304) which stores the activation (i.e. in a secure environment).

The next time the product 402-406 is launched, the product 402-406 asks the LMU 210 for the license at step 418 (at which point it is determined that the license exists). The LMU 210 then communicates with the SLMS 304 to obtain the license for the product 402-406 (at which point no additional enrollment or activation 422 is necessary).

### Graphical User Interface

Referring again to FIG. 3, a graphical user interface referred to as the dashboard 306 may be used to display the status of all of the products 102-106 controlled by the LMU 210 (since all products 102-106 share the common LMU 210). If several products 102-106 are installed on a computer, the user can launch the dashboard 306 to check the licensing status of each product 102-106. In addition, only a subset of applications 102-106 may be viewed by the dashboard 306 (e.g., those products installed and that utilize the LMU 210 or a common SLMS 304).

Target users of the dashboard 306 are administrators at a computer lab or a manager of a computer. The dashboard 306 may also be an independent executable/utility (e.g., that is executing on a client 204 or server 206). Such an independent application may be initiated/executed independently from the products 102-106 or LMU 210. For example, an application shortcut or executable may be selected on a user's desktop. In addition, activation of a product 102-106 may be initiated and performed through the dashboard 306. Once the user chooses to activate a product 102-106 in the dashboard 306, the individual applications 102-106 may be used to perform the actual activation sequence.

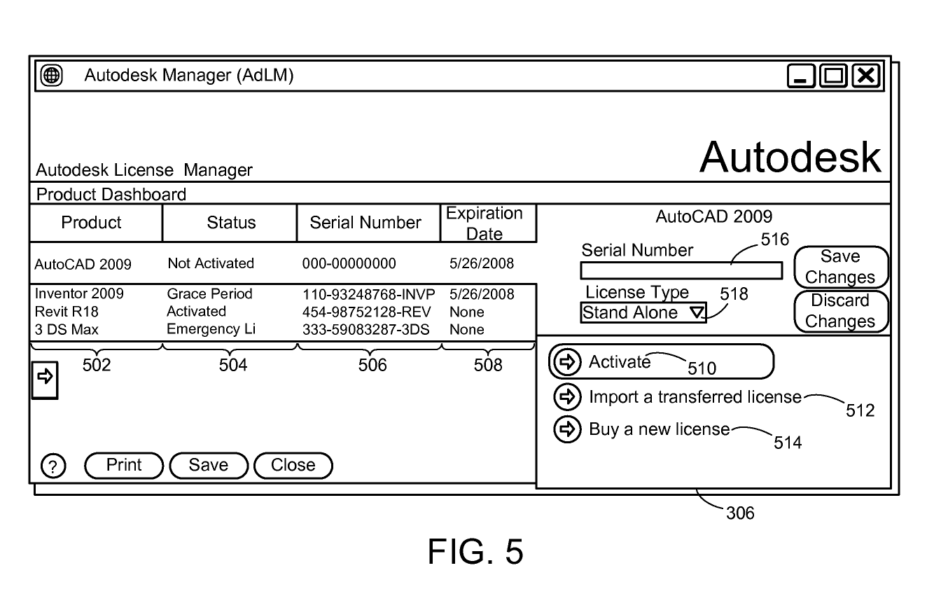

FIG. 5 illustrates a graphical user interface of a dashboard 306 displayed in accordance with one or more embodiments of the invention. A list of the products managed using the LMU 210 of the present invention is listed in a product column 502. Column 504 includes the current status of the license (e.g., activated, not activated, grace period, emergency license, etc.). Column 506 includes the unique serial number identifying the product. Column 508 identifies the expiration date, if any, for the license. The user may use the dashboard 306 to activate a license using button or link 510, import a transferred license using button or link 512, or buy a new license for the product using button or link 514. In addition, the user can update the serial number for a product (i.e., in field 516) and/or identify the license type (e.g., stand alone or network) for the product (i.e., in field 518).

In view of the above, the dashboard 306 may be used to assist the user in activating products, importing or exporting a transferred license to/from a particular computer, purchasing products, updating a product's serial number or license type, return a borrowed network license early, etc.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer implemented method activating one or more computer applications for use on a computer, comprising:
installing a first of the computer applications on the computer;
installing a single licensing management utility (LMU) that is shared by the one or more computer applications on the computer;
the LMU determining if a first license for the installed first computer application exists; and
the LMU obtaining the first license if the first license does not exist.

2. The method of claim 1 further comprising:
a software license management system application (SLMS) executing on the computer that manages licenses for the one or more computer applications;
storing activation information for one or more licenses for the one or more computer applications in the SLMS; and
the LMU communicating with the SLMS to obtain the first license for the first installed computer application.

3. The method of claim 2 wherein the SLMS stores the activation in an encrypted and secure form.

4. The method of claim 2 wherein the obtaining the first license comprises:
transmitting a request code, that identifies the installed first computer application, to a licensing party;
receiving, in the LMU, an activation code from the licensing party; and
the LMU passing the activation code to the SLMS.

5. The method of claim 2 wherein the LMU communicates with the SLMS using application programming interface (API) calls of a single licensing management component.

6. The method of claim 1 wherein the installing of the first computer application includes generating product information that identifies the first computer application being installed.

7. The method of claim 1 further comprising:
installing a second of the one or more computer applications on the computer;
determining that the LMU has already been installed on the computer;
the LMU determining if a second license for the second installed computer application exists; and
the LMU obtaining the second license for the second installed computer application if the second license does not exist.

8. An apparatus for activating one or more computer applications for use on a computer comprising:
(a) the computer having a memory;
(b) a first of the one or more computer applications installed on the computer; and
(c) a single licensing management utility (LMU), installed on the computer, that is shared by the one or more computer applications, wherein the LMU is configured to:
(i) determine if a first license for the installed first computer application exists; and
(ii) obtain the first license if the first license does not exist.

9. The apparatus of claim 8 further comprising a software license management system application (SLMS) executing on the computer that manages licenses for the one or more computer applications, wherein:
activation information for one or more licenses for the one or more computer applications is stored in the SLMS; and
the LMU communicates with the SLMS to obtain the first license for the first installed computer application.

10. The apparatus of claim 9 wherein the SLMS stores the activation in an encrypted and secure form.

11. The apparatus of claim 9 wherein the LMU obtains the first license by:
transmitting a request code, that identifies the installed first computer application, to a licensing party;
receiving, in the LMU, an activation code from the licensing party; and
the LMU passing the activation code to the SLMS.

12. The apparatus of claim 9 further comprising a single licensing management component that provides an application programming interface (API) that enables communication between the LMU and the SLMS.

13. The apparatus of claim 8 wherein the installing of the first computer application includes generating product information that identifies the first computer application being installed.

14. The apparatus of claim 8 further comprising a second of the one or more computer applications installed on the computer, wherein:
a determination is made that the LMU has already been installed on the computer;
the LMU determines if a second license for the second installed computer application exists; and
the LMU obtains the second license for the second installed computer application if the second license does not exist.

15. An article of manufacture comprising a program storage device embodying instructions that, when executed by a computer, cause the computer to perform a method for activating one or more computer applications for use on the computer, comprising:
installing a first of the computer applications on the computer;
installing a single licensing management utility (LMU) that is shared by the one or more computer applications on the computer;
the LMU determining if a first license for the installed first computer application exists; and
the LMU obtaining the first license if the first license does not exist.

16. The article of manufacture of claim 15 further comprising:
a software license management system application (SLMS) executing on the computer that manages licenses for the one or more computer applications;
storing activation information for one or more licenses for the one or more computer applications in the SLMS; and
the LMU communicating with the SLMS to obtain the first license for the first installed computer application.

17. The article of manufacture of claim 16 wherein the SLMS stores the activation in an encrypted and secure form.

18. The article of manufacture of claim 16 wherein the obtaining the first license comprises:
transmitting a request code, that identifies the installed first computer application, to a licensing party;
receiving, in the LMU, an activation code from the licensing party; and
the LMU passing the activation code to the SLMS.

19. The article of manufacture of claim 16 wherein the LMU communicates with the SLMS using application programming interface (API) calls of a single licensing management component.

20. The article of manufacture of claim 15 wherein the installing of the first computer application includes generating product information that identifies the first computer application being installed.

21. The article of manufacture of claim 15 further comprising:
installing a second of the one or more computer applications on the computer;
determining that the LMU has already been installed on the computer;
the LMU determining if a second license for the second installed computer application exists; and
the LMU obtaining the second license for the second installed computer application if the second license does not exist.
